(19) United States
(12) Patent Application Publication
(10) Pub. No.: US 2013/0271891 A1
(43) Pub. Date: Oct. 17, 2013

(54) Metallic Mesh and Lightning Strike Protection System

(71) Applicant: DEXMET CORPORATION, Wallingford, CT (US)

(72) Inventors: Harry B. Shimp, Chagrin Falls, OH (US); Kenneth E. Mull, Woodbridge, CT (US)

(73) Assignee: DEXMET CORPORATION, Wallingford, CT (US)

(21) Appl. No.: 13/761,316

(22) Filed: Feb. 7, 2013

Related U.S. Application Data
(60) Provisional application No. 61/623,806, filed on Apr. 13, 2012.

(51) Int. Cl. H02H 1/04

(52) U.S. Cl. CPC H02H 1/04
USPC 361/220; 428/545; 428/608; 427/125; 427/122; 427/58

(57) ABSTRACT

A lightning strike protection material has a metallic substrate and a metallic coating atop the substrate. The material may be integrated with a structural layer, the metallic coating composition being less reactive with material of the structural layer than is the composition of the metallic substrate.

### CROSS-REFERENCE TO RELATED APPLICATION

Benefit is claimed of U.S. Patent Application Ser. No. 61/623,806, filed Apr. 13, 2012, and entitled “Metallic Mesh and Lightning Strike Protection System”, the disclosure of which is incorporated by reference herein in its entirety as if set forth at length.

### BACKGROUND OF THE INVENTION

The invention relates to lightning protection. More particularly, the invention relates to fiber reinforced plastic (FRP) aerospace structures with foraminate metallic conductive layers.

Many structures may need protection from lightning. For example, lightning protection is a requirement on many fiber reinforced plastic (FRP) aerospace structures and other composite parts that may be subjected to lightning. While the FRP matrix may be conductive, the FRP structure may not disperse the highly concentrated energy from a lightning strike quickly enough to prevent delamination and embrittlement of the structure. A lightning strike on an unprotected FRP structure may thus result in complete failure, leaving a hole in the FRP structure.

Historically, one engineering approach to protecting FRP structures from lightning has been to include a thin layer of metal foil or screen in the outer layer of the composite. When struck by lightning, the metal layer is vaporized into a plasma ball which disburses the energy, thereby sacrificially protecting the FRP matrix underneath from severe damage. The metal outer surface layer may be solid foil or foraminate (e.g., expanded foil, woven wire screen, or wire interwoven into the FRP matrix).

US Pre-Grant Publications 20100103582 (the '582 publication) published Apr. 29, 2010 and 20100108342 (the '342 publication) published May 6, 2010, the disclosures of which publications are incorporated by reference in their entireties herein as if set forth at length, disclose particular lightning protection systems featuring perforated/expanded metal layers. Exemplary metals include copper and aluminum.

### SUMMARY OF THE INVENTION

One aspect of the invention is an article of manufacture comprising an aluminum-based or copper-based substrate. A silver-based coating is on the substrate. The substrate is embedded in a non-metallic matrix.

Another aspect of the invention is an article of manufacture comprising an aluminum-based or copper-based expanded metal mesh and a silver based coating on the mesh.

Another aspect of the invention is a lightning strike protection material comprising a metallic substrate and a metallic coating atop the substrate

In various implementations, the coating may be directly atop the substrate or an intermediate layer may be between the substrate and the coating. The article may further comprise an additional layer such as a carbon fiber layer.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a schematized cross-sectional view of a fiber reinforced plastic (FRP) material.

FIG. 2 is a partial view of an expanded metal mesh of the FRP of FIG. 1.

FIG. 3 is a schematic cross-sectional view of a strand of a metal layer in the mesh of FIG. 2.

FIG. 4 is a schematic cross-sectional view of an alternate strand.

Like reference numbers and designations in the various drawings indicate like elements.

### DETAILED DESCRIPTION

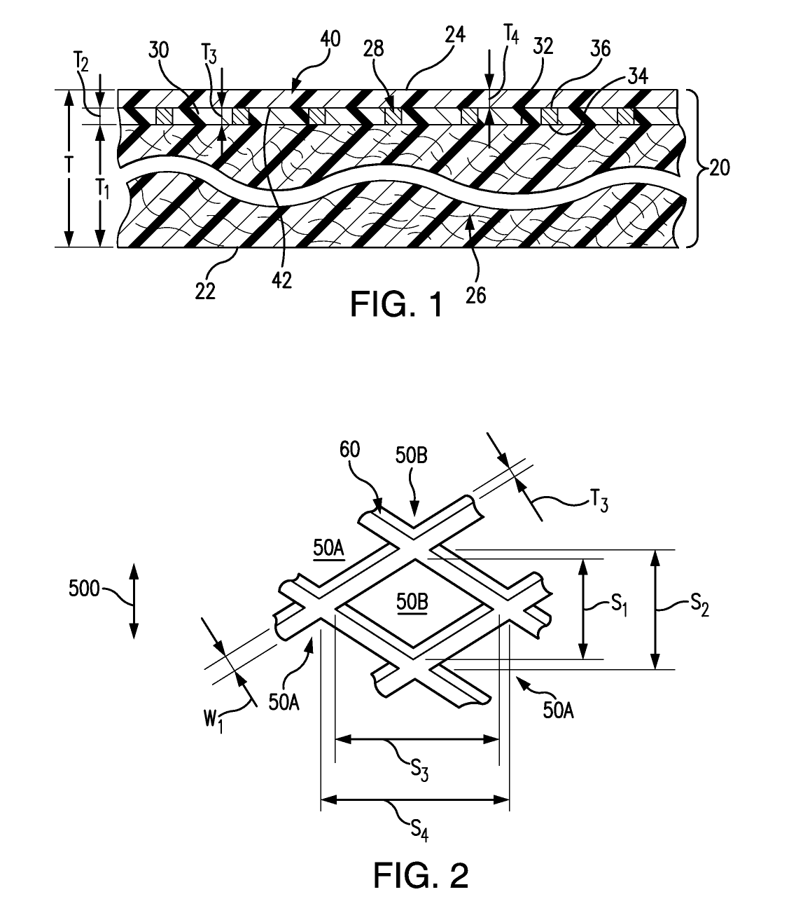

FIG. 1 shows a composite material 20 extending across a thickness T between a first surface 22 and a second surface 24.

The material comprises a resin-impregnated carbon (graphite) fiber layer 26 (which may be a group of individual fabric layers (sublayers)) and a foraminate (e.g., woven or perforated mesh) metallic member 28. The exemplary metal member 28 is embedded in a matrix 30 which may be of the same resin impregnating the carbon fiber. The exemplary carbon fiber layer 26 is shown having a thickness T₁ between an inboard face of the layer coincident with the inboard surface 22 and an outboard face 32 of the layer 26. As is discussed below, the carbon fiber layer serves the basic structural function, whereas the metallic member serves a lightning strike protection function.

The exemplary metallic member 28 has an inboard surface/face 34 along the carbon fiber layer outboard face 32 and an outboard surface 36 which may be part of or subflush to the surface 24. In the illustrated embodiment, a separately-formed surfacing layer 40 may be atop the outboard surface 36 of the metallic member and has an inboard surface 42 and an outboard surface which may form the second surface 24. This may provide improved appearance, paintability, wearability, and the like. Exemplary surfacing layers are epoxy or other resin and may be of the same composition as the matrix.

The exemplary metallic member comprises a foraminate copper-based or aluminum-based substrate. Both copper and aluminum suffer corrosion problems when in contact with graphite and exposed to moisture. The moisture exposure may be facilitated by microcracking. More particularly, even with a very thin matrix film initially between the metal and graphite, microcracking of the film will allow moisture infiltration to establish a galvanic reaction between the metal and graphite. The microcracking may be exacerbated by a combination of differential thermal expansion and sharp cut edges on the strands of mesh. Accordingly, a baseline (e.g., prior art) system may need one or more isolation layers between the mesh and the carbon fiber layers. An exemplary isolation layer comprises glass fiber (e.g., known as E-glass). Alternative isolation layers are plastic (e.g., as disclosed in the '582 publication).

When in contact with graphite, copper has approximately 60% of the galvanic reaction potential that aluminum does. However, corrosion is still typically an issue and thus the isolation layers may still be appropriate. Additionally, oxidation of the outer surface of the mesh may lead to or exacerbate microcracking in the outer layer of the FRP composite (e.g., the surfacing layer 40) as well as cosmetic discoloration. Thus, there may be a feedback loop of microcracking facilitating oxidation and oxidation causing/exacerbating microcracking. Additionally, use of very lightweight copper mesh may reduce electrical conduction ability.

Accordingly, an exemplary implementation of the metallic member 28 provides a silver-based coating (e.g., silver plating) on a copper-based or aluminum-based substrate used in an FRP composite. The galvanic potential of silver with graphite is 40% less than that of copper. This significantly reduces the tendency of the composite to exhibit microcracks and/or discoloration and may thus allow reduction of or total elimination of any isolation layer.

Furthermore, silver has approximately 10% higher conductivity than does annealed copper. Because almost all of the electric current flow in a conductor is along the outer surface, the addition of a silver outer layer provides a measurable increase in current carrying ability with essentially no added weight.

A further possible advantage is that the coating may provide a somewhat smoother interface with the matrix than would the mesh substrate alone (reducing stress concentrations).

Advantages relative to aluminum are even more significant wherein the silver/graphite galvanic potential is 60% less than the aluminum/graphite galvanic potential and the silver has 80% greater conductivity than does aluminum. Thus, the use of silver plating may allow elimination of the glass fiber, plastic, or other isolation layer. This allows essentially direct contact between the mesh and the carbon fiber material (e.g., with whatever slight thickness of matrix material might intervene).

The exemplary metallic member 28 is an expanded metal mesh. An exemplary expanded metal mesh is formed by perforating a metallic sheet (e.g., foil of the copper-based or aluminum-based material) with two alternating sets of slits and stretching to transversely open the slits to form a diamond mesh pattern. The exemplary slitting and expansion may be performed in a single step or at least some of the expansion may come after the slitting.

FIG. 2 shows an expanded metal mesh post-expansion with two alternating interspersed sets of expanded slits 50A and 50B. FIG. 2 also shows the direction of expansion 500.

FIG. 2 further shows a thickness of the mesh T₃ between the faces of the sheet which may be essentially coincident with a thickness T₂ of the matrix 30 in FIG. 1. T₃ reflects the thickness of the sheet material used to form the expanded mesh subject to any flattening process, any deburring or smoothing process, and subject to the thickness of the plating layer(s). FIG. 2 further shows individual strands 60 of the mesh having a strand width W₁. FIG. 2 also shows the SWD (short way of the diamond) dimensions S₁ for the expanded slits and S₂ for the overall pitch. FIG. 2 further shows the LWD (long way of the diamond) dimensions S₃ for the expanded slits and S₄ for the pitch. The difference between S₃ and S₄ will relate to the width Wᵢ.

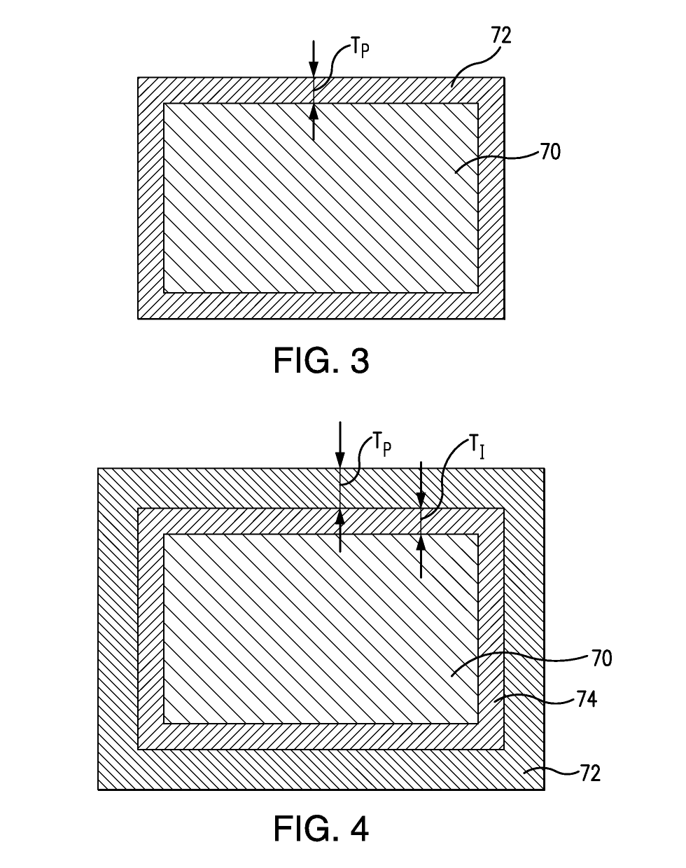

FIG. 3 is a cross-sectional view of an individual strand of the mesh showing the copper-based or aluminum-based substrate 70 with the silver-based coating 72 thereatop at a thickness T_{P}. Exemplary T_{P} is 0.5 mil nominal, more broadly 0.1-1.0 mil nominal or 0.3-0.7 mil nominal (12.7 micrometer, more broadly, 2.5-25 or 8-18 micrometer). Nominal sheet thicknesses may be subject to industry standards and may represent average (e.g., mean/median/modal) values. Coating thicknesses will be expected to have more variation and similarly may represent average values.

Exemplary copper-based alloy is C110 or ED copper at a thickness of 1.0-20.0 mil nominal, more narrowly, 1.5-3 mil nominal (25-510 micrometer, more narrowly, 38-76 micrometer). An exemplary aluminum-based alloy is 1145 or 1235 at a similar thickness to the copper, with a particular nominal of 2-4 mil (50-102 micrometer). An exemplary silver coating is essentially pure silver applied via plating (e.g., electroplating).

In an exemplary process of manufacturing the composite material, a tool (mold) is provided having a shape corresponding to the shape of a surface of the part (e.g., 24). The surface layer may be applied. An exemplary application involves partially cured pre-formed sheet material (which may be kept chilled in a freezer prior to use). Exemplary material for the surfacing layer is epoxy or other resin of the same nominal composition as that used in the matrix. Alternatively, there may be different chemistries between the two. Exemplary surfacing material thickness T₄ may be 1-5 mil nominal, more particularly, 2-4 mil nominal (25-130 micrometer, more particularly, 50-102 micrometer). Although illustrated as distinct from the matrix material infiltrating the mesh, in practice there may be no apparent boundary.

Exemplary surfacing material is roll-formed with release paper (or other release sheet) on one surface. In composite lay-up, a liquid or semi-liquid release agent may first be applied to the mold/tool surface as in conventional manufacture. The exposed face of the surfacing material may then be applied to the mold. The release paper may then be peeled off. The silver-coated mesh may then be applied atop the surfacing layer.

The carbon fiber material for the layer 26 may be then applied in one or more layers (of woven sheets, tapes, tows, or the like) via various known or yet-developed techniques. The material may be fully, partially, or not at all pre-impregnated with the resin. Resin (e.g., epoxy) may, thereafter, be applied to the carbon fiber material. The tool may then be bagged and vacuum applied to remove air and compress the material. The material may then cure (e.g., via autoclave). After at least partial curing, the bag may be removed and the composite material removed from the tool. There may be subsequent processings including, but not limited to, cleanings, finish machinings, surface treatments, painting, or application of additional layers. The components formed by the material may then be assembled in the ultimate aircraft or other product.

Candidate locations for use as a lightning strike protection material include: airframe (particularly skin portions thereof) including fuselage, wings, stabilizers and their subcomponents; external structures (e.g., engine nacelles, external fuel tanks, external weapon pods, electronic pods or other pods); internal structures (e.g., fuel tanks, equipment housings); propellers; and rotors. Similar uses may attend composite land vehicles or water vessels or windmill components (e.g., blades). Non-lightning applications may include radiofrequency isolation/containment (e.g., Faraday cages). When used to make any such otherwise conventional product, existing or yet-developed manufacturing techniques and basic materials may be used to which the exemplary silver-coated material is added (e.g., as merely an extra ply during layup with the composite in the appropriate tool).

As noted above, the exemplary silver-plated mesh is directly adjacent one or more carbon fiber layers. This thus eliminates the use of a glass fiber layer or plastic layer which has been used in prior proposals to isolate a copper or aluminum mesh from galvanic interaction with the carbon fiber. However, that does not preclude use of an isolation or other layer.

In yet further variations, the mesh may be sandwiched between layers in the composite.

In yet further variations, other layers are present. For example, this may include one or more layers such as those shown in the '582 publication. One group of such materials includes the presence of metallic or non-metallic honeycomb layers. In a particular example, a honeycomb (e.g., aluminum-based or aramid) may be sandwiched between two groups of layers of carbon fiber (e.g., and secured thereto via the same resin impregnating the carbon fiber. The metallic material may (with or without intervening isolation layer) be atop the outer of the two groups of carbon fiber layers.

In yet further variations, the foraminate material may be other than expanded mesh (e.g., woven screen or strands placed or interwoven with one or more of the carbon fiber layers).

In a further variation of any such variation, an intermediate layer 74 (FIG. 4) may be applied to the expanded aluminum-based or copper-based substrate 70 to improve intermetallic bonding with the silver 72. Particularly, bond strength between the intermediate layer and the substrate and bond strength between the intermediate layer and the silver-based layer may both be greater than corresponding bond strength between a similar (and similarly applied) silver layer applied directly to the substrate. Bonding weakness may be particularly significant with aluminum-based substrates. With such an aluminum-based substrate, an exemplary intermediate layer is nickel-based. More particularly, an exemplary intermediate layer is a plating (e.g., electroplating) of pure nickel at a thickness T_{I}. Exemplary T_{I} is is of the same ranges as T_{P} noted above micrometer, while T_{P} may remain as discussed above.

Yet alternative variations may include further variations on substrate and coating material. There may also be variations on the structural material beyond carbon fiber. The advantages of any substrate/coating combination may be influenced by the particular structural material. Thus, generally, the coating material composition will be less reactive with (have a lower galvanic potential with) the structural material than is/does the substrate composition.

One or more embodiments of the present invention have been described. Nevertheless, it will be understood that various modifications may be made without departing from the spirit and scope of the invention. For example, when implemented in the re-design or re-engineering of an existing component, details of the existing component, its materials, and manufacturing techniques may influence details of the particular implementation. Accordingly, other embodiments are within the scope of the following claims.

What is claimed is:

1. An article of manufacture comprising:
an aluminum-based or copper-based substrate;
a silver-based coating on the substrate; and
a non-metallic matrix in which the substrate is embedded.

2. The article of claim 1 wherein:
the substrate is an expanded mesh.

3. The article of claim 1 wherein:
the coating is directly atop the substrate.

4. The article of claim 1 further comprising:
an intermediate layer between the substrate and the coating.

5. The article of claim 4 wherein:
the intermediate layer is nickel-based.

6. The article of claim 1 further comprising:
a carbon fiber layer.

7. The article of claim 6 wherein:
there is no intervening fiber or film layer between the carbon fiber layer and the substrate.

8. The article of claim 1 being an aerospace structure selected from the group consisting of:
an aircraft airframe; external structure mounted to an aircraft; aircraft propellers and rotors, rocket fuel tanks, land motor vehicle bodies, and windmill components

9. A method for forming the article of claim 1, the method comprising:
perforating and expanding a metallic sheet to form the substrate;
plating the silver-based coating onto the substrate;
embedding the plated substrate in uncured material for said matrix; and
curing the matrix.

10. A method for forming the article of claim 1, the method comprising:
positioning, in a tool, the substrate with said coating on the substrate;
positioning, in the tool, at least one carbon fiber layer;
introducing a matrix precursor;
vacuum bagging the at least one carbon fiber layer, coated substrate, and matrix precursor; and
curing the precursor to form the matrix.

11. The method of claim 10 wherein one-to all of:
a surfacing layer is positioned in the tool prior to the positioning of the substrate;
the substrate is positioned prior to the positioning of the at least one carbon fiber layer;
no additional carbon fiber layers are positioned in the tool prior to positioning the substrate; and
the at least one carbon fiber layer is a prepreg so that the matrix precursor is introduced with the positioning of the carbon fiber layer.

12. An article of manufacture comprising:
an aluminum-based or copper-based expanded metal mesh; and
a silver-based coating on the mesh.

13. The article of claim 12 further comprising:
an intermediate layer between the mesh and the coating, the intermediate layer improving bonding between the coating and the mesh.

14. The article of claim 13 wherein:
the intermediate layer is nickel-based.

15. The article of claim 14 wherein:
the expanded metal mesh is aluminum-based; and
the article consists essentially of the mesh, the coating, and the intermediate layer.

16. A method for manufacturing the article of claim 13, the method comprising:
perforating and expanding a metal sheet;
applying the intermediate layer; and
applying the coating.

17. A method for manufacturing the article of claim 12, the method comprising:
perforating and expanding a metal sheet; and
coating the perforated and expanded sheet with the coating.

18. A lightning strike protection material comprising:
a metallic substrate; and
a metallic coating atop the substrate.

19. The lightning strike protection material of claim 18 wherein:
the metallic coating is more electrically conductive than the metallic substrate.

20. The lightning strike protection material of claim 18 further comprising:
a structural layer, the metallic coating composition being less reactive with material of the structural layer than is the composition of the metallic substrate.

21. The lightning strike protection material of claim 18 wherein:
the metallic substrate is a copper-based or aluminum-based material; and
the metallic coating is a silver-based layer atop the copper-based or aluminum-based material.

22. The lightning strike protection material of claim 21 being a mesh and wherein and one or more of:
the silver-based layer is an outermost layer of the mesh;
the silver-based layer is directly atop the copper-based material or aluminum-based material; and
the copper-based material or aluminum-based material is a core material, not a coating.

23. A method for using the the lightning strike protection material of claim 18 comprising:
allowing the material to be struck by lightning.
